(19) United States
(12) Patent Application Publication
(10) Pub. No.: US 2005/0071494 A1
(43) Pub. Date: Mar. 31, 2005

(54) Method and apparatus for providing fixed bandwidth communications over a local area network

(76) Inventors: William A. Rundquist, Livermore, CA (US); Michael E. Golden, Sedona, AZ (US)

Correspondence Address: WONG, CABELLO, LUTSCH, RUTHERFORD & BRUCCULERI,;P.C., 20333 SH 249, SUITE 600, HOUSTON, TX, 77070, US

(21) Appl. No.: 10/676,207

(22) Filed: Sep. 30, 2003

(51) Int. Cl. G06F 15/16; G06F 15/173

(52) U.S. Cl. 709/232; 709/223

(57) ABSTRACT

The present invention is a method and apparatus for transferring data between a wide area network and a computer system located on an Ethernet type local area network. When characterized as a method, the present invention initially receives data from the wide area network using a digital device that is connected to both the wide area network and the local area network, the data received by the digital device being destined for a computer system attached to the local area network. Next, the digital device receives a signal from systems in the wide area network indicating that the data is to be transferred to and from the computer system at a predetermined guaranteed quality of service (QoS) and bandwidth. Packets that contain the data are then formatted to indicate that the data is to be transmitted at a “guaranteed” rate of throughput higher than the minimum rate. Finally, the packets that contain the data are sent to the computer system, thereby establishing a communication link for the packet stream between the wide area network and the local area network that transmits data at the guaranteed QoS.

### BACKGROUND OF THE INVENTION

The present invention relates generally to a digital network that can dynamically establish communication links between digital devices with a guaranteed quality of service (QoS). More specifically, the present invention enables a digital device located at the edge of a wide area network to establish a communication link that can transmit data at a guaranteed bandwidth to computer systems located on an Ethernet network.

Developing equipment and methods for dynamically establishing communication links that have a guaranteed amount of bandwidth on a wide area network (such as the Internet) is an ongoing problem for the communications industry. As many have come to realize, reliably constructing such links is sufficiently complex and involves so many different systems that no one “plan” or solution can be applied to the entire problem. Instead, solutions are gradually being developed within the framework of the equipment and standards which exist today that address individual parts of the problem.

Generally, the extent to which a communication network, comprised of communication links, can guarantee a certain amount of bandwidth at a guaranteed quality of service (QoS) is constrained by the least reliable (or least “guaranteed”) link in the network. Local area networks (LANs), due to their popularity, are often links in such communication networks. As importantly, these LANs are the link through which many access larger communication networks, such as the Internet. Thus, guaranteeing bandwidth at a particular QoS on LANs is an important part of providing predetermined amounts of bandwidth at a particular QoS on an end-to-end basis.

Many local area networks are known as “Ethernet” type networks, and operate according to the 802 Standard promulgated by the IEEE. Examples of these networks include networks typically found in an office environment, as well as many DSL lines. The acronym “DSL” stands for digital subscriber line technology, and allows for data to be transmitted from a telephone company's central office to an end device (e.g., a computer in someone's home or office) at speeds in the 1 Mbps range. While a DSL line is not a traditional Ethernet network, the data transmitted over many DSL lines is transmitted according to the Ethernet standard.

Due to the increased bandwidth capacity available on DSL lines and Ethernet networks in general, along with the increasing amounts of bandwidth available over the Internet and private overlay IP networks, streaming of high-quality audio and video over wide area networks to end devices is now possible. However, with the ability to provide the necessary bandwidth for these applications comes the need to effectively reserve bandwidth for each stream, not only on the wide area networks but over local Ethernet networks as well, to ensure that these applications can obtain the bandwidth and QoS necessary for their proper operation. The need for bandwidth reservation on Ethernet networks exists now, and will only increase in the future. For example, in a home today, video and sound systems that receive their content over wide area IP networks or the Internet compete with multiple computers, “smart” devices and appliances, and the like, to receive multiple streams of data over a single DSL line. This competition is likely to increase in the future as such devices become more prevalent and advanced.

Thus, there exists a need for a method and device that can be integrated into equipment that allows certain streams of data to be delivered at a dynamically selectable, fixed-bandwidth to end devices on an Ethernet network. This method and device should also be as compatible as possible with existing standards, yet provide efficient and reliable service.

### SUMMARY OF THE INVENTION

Generally, the present invention is a method and apparatus for transferring data between a wide area network and a computer system located on an Ethernet type local area network. When characterized as a method, the present invention initially receives data from the wide area network using a digital device that is connected to both the wide area network and the local area network, the data received by the digital device being destined for a computer system attached to the local area network. Next, the digital device receives a signal from systems in the wide area network indicating that the data is to be transferred to and from the computer system at a predetermined guaranteed quality of service (QoS) and bandwidth. Packets that contain the data are then formatted to indicate that the data is to be transmitted at a “guaranteed” rate of throughput higher than the minimum rate. Finally, the packets that contain the data are sent to the computer system, thereby establishing a communication link for the packet stream between the wide area network and the local area network that transmits data at the guaranteed QoS.

When characterized as an apparatus, the present invention includes a content provider, a network control system server, and a digital device. The content provider is adapted to broadcast data destined for a computer system, with the computer system being attached to a local area network. The network control system server is adapted to send guaranteed QoS requesting signals to the digital device. The digital device is adapted to receive data from the content provider over a wide area network, receive the guaranteed QoS requesting signal from the network control system server, format the data received to indicate that the data is to be transmitted at the specified QoS, and service and send the data on to the computer system thereby establishing a communication link between the wide area network and the local area network that transmits data at the designated guaranteed QoS.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a communications network and a series of computers upon which the present invention can be implemented; and

FIG. 2 is a flowchart that illustrates a method of operation according to the present invention.

### DETAILED DESCRIPTION OF THE INVENTION

Generally, the present invention is a method by which a network communication device at the edge of a wide area network (WAN) establishes a communication link, having a guaranteed minimum amount of bandwidth, with computer systems located on an Ethernet network. Initially, the network communication device, which is typically a router, receives a stream of data being sent to a computer systems attached to an Ethernet network. In response to a signal, the router will establish a communication link with the computer system according to the Ethernet provisions that allow for communications to occur at a relatively fixed data rate. Then, the data destined for the computer system is delivered over this link at a relatively fixed rate, thereby allowing for a high QoS (quality of service) level to be maintained.

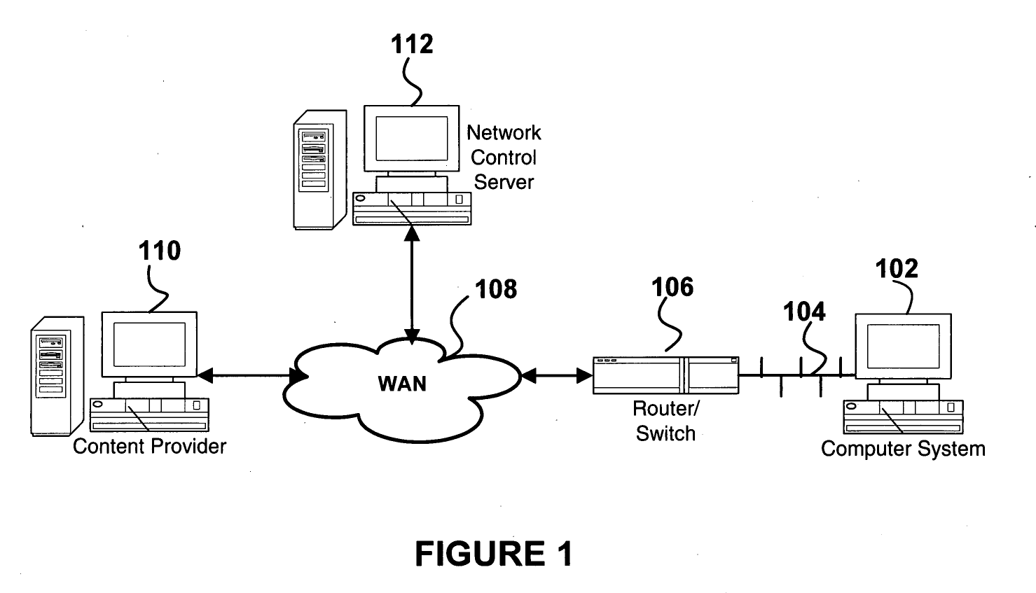

FIG. 1 shows a computer network upon which the present invention can be implemented. Computer system 102 is attached to a local are network (LAN) 104. LAN 104 is an Ethernet network, as that term is know in the art, and data is transmitted on LAN 104 according to the IEEE (Institute of Electrical and Electronic Engineers) 802 standard. Although not shown in FIG. 1, numerous other devices such as additional computer systems, routers, and networks are normally attached to a LAN such as LAN 104.

LAN 104 is attached to wide area network (WAN) 108 via router/switch 106. WAN 108 can be the Internet, or it can be a private wide area network. Additionally, as will be described below, WAN 108 may be a packet or circuit switched, public or private switched network infrastructure that operates independently or in cooperation with the public Internet packet-routed infrastructure. Router/switch 106 allows data to be passed between LAN 104 and WAN 108. Router/switch 106 can be connected to WAN 108 by almost any type of network such as ATM, Sonnet, MPLS, etc. Router/switch 106 functions as a normal router in that it can transmit information between WAN 108 and LAN 104. Specifically, the portion of the router that sends and receives data with LAN 104 complies with the 802 Ethernet standards, and particularly with Ethernet standards 802.1P and 802.1Q.

Additionally, router/switch 106 is adapted so that it can communicate with network control system server 112, and perform as directed by network control system server 112. In one mode of operation, network control system server 112 can direct router/switch 106 to initiate a communication session using the protocols described in the 802.1P (which is part of the 802.1D standard) and 802.1Q standards (hereinafter referred to collectively as the “Ethernet QoS protocols”) with computer systems 102. Once such a session is established, data can be exchanged between router/switch 106 and computer system 102 at a relatively constant rate, thereby providing a guaranteed QoS. As was the case for LAN 104, and in order to clarify FIG. 1, many devices such as additional routers, switches, and servers that are normally attached to a WAN such as WAN 108 have been intentionally not included.

Also attached to WAN 108 is content provider 110. Such a device is often a web site or file server that contains information to be transferred across WAN 108 and LAN 104 to computer system 102. In the alternative, in the case of peer-to-peer communications, content provider 110 can be a device similar to computer system 102. For example, if two users wish to engage in a video conference across WAN 108, from the perspective of each of the user's computer systems, the other computer system would be considered a content provider, since each system would be providing information to the other across WAN 108. Thus, any device capable of sending data over a WAN to a computer system such as computer system 102 is to be considered a content provider.

Controlling, in part, the operation of WAN 108 is network control system server 112. In one embodiment of the present invention, this control server controls the paths taken by information as it travels over WAN 108. Such control is important to provide a guaranteed QoS for specific data steams. In this embodiment, WAN 108 and network control system server 112 can be implemented as described in U.S. Pat. No. 6,272,127, entitled “Network for Providing Switched Broadband Multipoint/Multimedia Intercommunications,” issued Aug. 7, 2001 (hereinafter “'127 patent”) which is hereby incorporated by reference.

With this illustrative embodiment, bandwidth intensive communication sessions, such as video and voice, may be implemented using WAN 108, while other communication sessions are transmitted using the conventional public Internet routed packet infrastructure. For example, to initiate a packet or circuit switched communication session, content provider 110 may request that network control system server 112 establish a circuit-switched communication path across WAN 108 at a given QoS. The network control system server 112 may reserve a communication route using the circuit or MPLS/IP transport resources of public telephone companies based on the bandwidth requirements of the data transmission and the IP address of content provider 110 and computer system 102.

As will be described below, the present invention discloses how to maintain a guaranteed QoS once information leaves the WAN and moves onto the LAN. More specifically, the present invention discloses how to transmit data at a selectable minimum data rate form a router/switch at the edge of a WAN, such as router/switch 106, to a computer system located on an Ethernet network, such as computer system 102.

As used in the specification and claims, the term “guaranteed QoS” refers to guaranteeing the transmission of data at a continuous average throughput rate required by a particular application for that application to perform satisfactorily. The rate at which data is transferred to achieve a guaranteed QoS will vary for different applications. For example, the rate at which information must be transmitted to achieve a guaranteed QoS for a video application will generally be higher than for a comparable audio application. Also, depending on the application, transmitting data at a guaranteed QoS can mean that the transferred data is guaranteed to have a certain level of average latency and latency variability (jitter).

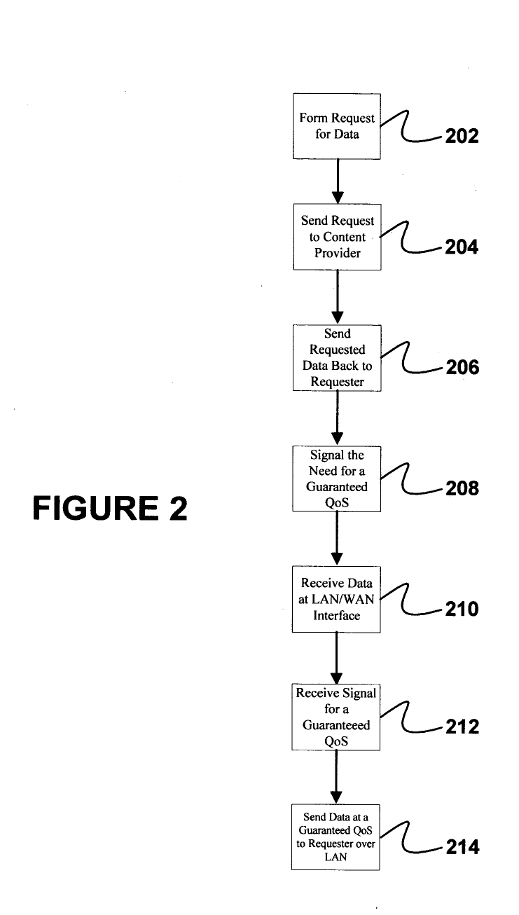

FIG. 2 illustrates a flowchart of the method by which a guaranteed QoS connection is established form a router/switch that connects a WAN and LAN, to a computer system located on the LAN. Initially, a user and/or a process operating on a computer system forms a request to receive data from a data source located on a WAN (202). A user (or a software application) can form a request to obtain data from a content provider connected to the WAN in any one of a number of ways. For example, a user can use a web browser to retrieve data from a web site as is known in the art and software on the web site can send a request to the network control system server for the high QoS connection. In addition, a user can use specialized software, such as video conferencing software, to send a request to the network control system server for data from another device connected to the WAN.

Once formed, the request is processed by the network control system server, and the network control system server sends a QoS connection message to the content provider (204) and to the router/switch. The router/switch then translates this received request into a standard 802.1P/802.1Q session initiation between the targeted user's computer on the LAN and the router/switch itself. Normally, this same session is initiated by the targeted user's computer on the LAN, not the router/switch.

Once the end-to-end QoS path is established, the content provider system handshakes with the software application on the user's computer and begins to transmit the requested data back to the computer system (206). Again, the manner in which a content provider, such as a web site, responds to a request for information received from the Internet is well known in the art. However, the present invention is not limited to such communications. As mentioned above, other communication systems, such as the one described in the '127 patent, are within the scope of this invention.

At approximately the same time the content provider receives the request, it also signals that the data it is providing to the computer system needs to be sent to the computer system with a guaranteed QoS (208). Such signaling can be done in a variety of ways. In some embodiments, such as the one discussed above in FIG. 1, the content provider can send a message to a network control system server. This manner of operation is described in the above-incorporated '127 patent. Alternatively, the content provider can indicate the need for a guaranteed QoS in the data itself by embedding information describing the content provider's request for a guaranteed QoS within the data being transmitted to the computer system.

Ultimately, the information from the content provider reaches the router that connects the WAN and the LAN to which the computer system is connected (210). In addition, the router/switch receives a signal requesting that the data from the content provider be sent to the computer system at a guaranteed QoS (212). As described above, the signal received by router requesting a guaranteed QoS can come form several places. The signal can be sent by the network control system server prior to the arrival of the actual data, as described in the '127 patent, or the signal can be embedded in the data itself. For example, in one embodiment, the signal may be embedded in a header field that precedes the data received by the router/switch. The header field may be a one-byte information field that signals the router to implement a designated QoS for the incoming data, where one bit in the header field is set to alert the router/switch that a minimum QoS is being requested while the remaining bits in the header field designate the QoS desired.

When the router/switch receives the signal requesting that a guaranteed QoS connection be formed between itself and the computer system connected to the LAN, the router begins communicating with the computer system according to the Ethernet QoS protocols that allow for two devices to exchange information with a guaranteed QoS. The specific manner in which the router exchanges data with the computer system at a guaranteed QoS is detailed in the Ethernet standard itself, which is available from the IEEE. Generally, however, such a session relies on the 802.1P and 802.1Q protocols specified by the 802 Ethernet standard.

Upon receiving messages as described above, the computer system will receive the information and respond appropriately since it, like the router/switch, complies with the Ethernet standard. It is important to note that other routers, bridges, and the like, may be located between the router and the computer system. However, as long as these other (106) devices fully implement the Ethernet standard, they will also forward the information on to the computer system with the same guaranteed QoS.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to: (a) information permanently stored on non-writeable storage media (e.g. read only memory devices within a computer such as ROMs or CD-ROM disks readable only by a computer I/O attachment); (b) information alterably stored on writeable storage media (e.g. floppy disks and hard drives); or (c) information conveyed to a computer through communication media, such as a local area network, a telephone network, or a public network like the Internet. It should be understood, therefore, that such media, when carrying computer readable instructions that direct the method functions of the present invention, represent alternate embodiments of the present invention.

While the invention has been particularly shown and described with reference to a preferred embodiment, it will be understood by those skilled in the art that various changes in form and detail may be made therein without departing from the spirit and scope of the invention.

1. A method for transferring data between a wide area network and a computer system located on an Ethernet type local area network, comprising:
receiving data from the wide area network at a digital device that is connected to both the wide area network and the local area network, the data being destined for a computer system attached to the local area network;
receiving a signal indicating that the data is to be transferred to the computer system at a specified bandwidth with guaranteed quality of service;
formatting packets that contain the data to indicate that the data is to be transmitted at the requested guaranteed quality of service;
sending the packets that contain the data to the computer system, thereby establishing a communication link between the wide area network and the local area network that transmits data at the requested guaranteed quality of service.

2. The method of claim 1, further comprising sending a signal from a network control system server to the digital device, wherein the signal indicates that the data is to be transferred to the computer system at the guaranteed quality of service.

3. The method of claim 1, further comprising:
receiving a request for data to be send from a content provider to the computer system; and
embedding priority information in the data, wherein the priority information signals that the data is to be delivered to the computer system at the rate higher than the requested guaranteed quality of service.

4. The method of claim 1, further comprising:
placing the packets containing the data to be sent to the computer system in a high priority queue; and
transmitting packets in the high priority queue before transmitting packet in corresponding low priority queues.

5. The method of claim 1, wherein the formatting step further comprises inserting priority information into headers associates with the packets, wherein packets having headers with high priority information are transmitted before packets having headers with low priority information.

6. The method of claim 1, wherein receiving a signal indicating that the data is to be transferred at a guaranteed quality of service further comprises receiving a signal indicating that the data is to be transferred to the computer system at a rate higher than a specified minimum rate.

7. A method for transferring data between a wide area network and a computer system located on an Ethernet type local area network, comprising:
receiving data from the wide area network at a digital device that is connected to both the wide area network and the local area network, the data being destined for a computer system attached to the local area network;
receiving a signal indicating that the data is to be transferred to the computer system at a rate higher than the specified minimum rate;
formatting packets that contain the data to indicate that the data is to be transmitted at a rate higher than the minimum rate; and
sending the packets that contain the data to the computer system, thereby establishing a communication link between the wide area network and the local area network that transmits data at the rate higher than the specified minimum rate.

8. A system for transferring data between a wide area network and a computer system located on an Ethernet type local area network, comprising:
a content provider adapted to broadcast data destined for the computer system; and
a network control system server adapted to send a guaranteed quality of service signal to a digital device that is attached to the local area network, wherein the digital device is operable in one mode of operation to
receive data destined for the computer system from the content provider over the wide area network;
receive the guaranteed quality of service signal from the network control system server, wherein the guaranteed quality of service signal specifies a guaranteed quality of service;
format the data to indicate that the data is to be transmitted over the local area network at the specified guaranteed quality of service; and
send the data to the computer system, thereby establishing a communication link between the wide area network and the local area network that transmits data at the specified guaranteed quality of service.

9. The system of claim 8, wherein the wide area network is one of a circuit-switched public switched telephone network infrastructure (PSTN).

10. The system of claim 9, wherein the network control system server is adapted to establish a dedicated communication route between the content provider and the digital device through the circuit-switched infrastructure based on a desired guaranteed quality of service over the WAN and the respective IP addresses of the content provider and the computer system.

11. The system of claim 8, wherein the wide area network is one of a circuit-switched or packet-switched public or private network infrastructure.

12. The system of claim 11, wherein the network control system server is adapted to establish a dedicated communication route between the content provider and digital device through the circuit-switched or packet-switched or packet-switched infrastructure based on a desired guaranteed quality of service over the WAN and the respective IP addresses of the content provider and the computer system.

13. A computer readable program storage device encoded with instructions that, when executed by a computer, transfers data between wide area network and a computer system located on an Ethernet type local area network, comprising:
receiving data from the wide area network at a digital device that is connected to both the wide area network and the local area network, the data being destined for a computer system attached to the local area network;
receiving a signal indicating that the data is to be transferred to the computer system at a guaranteed quality of service;
formatting packets that contain the data to indicate that the data is to be transmitted at the specified guaranteed quality of service; and
sending the packets that contain the data to the computer system, thereby establishing a communication link between the wide area network and the local area network that transmits data at the specified guaranteed quality of service.

14. A system for transferring data between a wide area network and a computer system located on an Ethernet type local area network, comprising:
means for receiving data from the wide area network at a digital device that is connected to both the wide area network and the local area network, the data being destined for a computer system attached to the local area network;
means for receiving a signal indicating that the data is to be transferred to the computer system at a guaranteed quality of service;
means for formatting packets that contain the data to indicate that the data is to be transmitted at the specified guaranteed quality of service; and
means for sending the packets that contain the data to the computer system, thereby establishing a communication link between the wide area network and the local area network that transmits data at the specified guaranteed quality of service.
